(19) United States
(12) Patent Application Publication
(10) Pub. No.: US 2014/0013648 A1
(43) Pub. Date: Jan. 16, 2014

(54) Fishing Lure With Retractable Hook

(71) Applicant: Bernard Hilton Yong-Set, Toronto (CA)

(72) Inventor: Bernard Hilton Yong-Set, Toronto (CA)

(73) Assignee: Centro Corporation, Koyang-City (KR)

(21) Appl. No.: 13/545,040

(22) Filed: Jul. 10, 2012

(51) Int. Cl. A01K 85/02

(52) U.S. Cl. 43/42.41

(57) ABSTRACT

A weedless fishing lure has a a body resembling live bait. The body has a longitudinal cavity which is open at the top, and a fish hook at least partially received in the cavity. A spring inside the body biases the hook toward the retracted position. The hook includes a point, a bend, a shank, a first attachment portion at an end of the shank opposite to the bend, and a second attachment portion projecting from the shank between the first attachment portion and the bend, and defining an eye for attaching a fishing line. The first attachment portion defines a transverse pivot axis about which the fish hook is pivotable between a retracted position in which the point of the hook is hidden inside the body, and an extended position in which it protrudes above the top of the body

### FIELD OF THE INVENTION

The invention relates to artificial fishing lures, and particularly to weedless fishing lures in which the hook is pivotable into and out of the body of the lure.

### BACKGROUND OF THE INVENTION

Artificial fishing lures are constantly being improved in order to provide greater ease of use and to catch more fish. One particular type of lure developed over recent years is the “weedless” fishing lure. Weedless lures are provided with one or more mechanisms for preventing the hook from becoming caught on water plants or other objects in the body of water being fished. Commonly, such mechanisms include a flexible metal member which covers and protects the point of the hook from becoming caught on aquatic vegetation, but is easily bent out of the way when a fish strikes the lure.

Weedless lures are also known in which the hook is pivotable between a first position in which the point of the hook is located within the body of the lure, and an extended position in which the point is exposed when a fish strikes the lure. An example of such a lure is disclosed in U.S. Pat. No. 6,772,552 to Parrish. However, the lures disclosed by Parrish are generally difficult to manufacture and/or inconvenient to use. For example, Parrish provides features such as detents to prevent unwanted pivoting of the hook, but the mechanisms proposed by Parrish fail to return the hook to its original, retracted position. Therefore, assuming the user notices that the point of the hook has become exposed during use, the user must push the hook back into the body of the lure every time the hook pivots away from the retracted position. Furthermore, the point at which the hook is attached to the fishing line is located within the body of the lure, meaning that the lure is likely to be sold with a piece of fishing line already attached to it. When this line breaks and needs to be replaced, it is difficult for the user to tie a fishing line onto the hook.

Therefore, there is a continued need for weedless fishing lures which are more effective and easier to use.

### SUMMARY OF THE INVENTION

In one aspect, there is provided a fishing lure, comprising: (a) a body having a top, a bottom, a front end and a rear end, with a longitudinal axis being defined between the front end and the rear end of the body; (b) a cavity defined within the body, wherein the cavity extends along the longitudinal axis and is open at the top of the body; (c) a fish hook at least partially received in the cavity; and (d) a spring located inside the body and attached to the hook, wherein the spring biases the hook toward the retracted position.

The fish hook comprises: (i) a pointed end and a bend located toward the rear end of the body; (ii) a shank extending from the bend, wherein the shank extends toward the front end of the body; (iii) a first attachment portion located at an end of the shank opposite to the bend of the fish hook, wherein the first attachment portion defines a transverse pivot axis about which the fish hook is pivotable between a retracted position in which the point of the hook is located inside the body, and an extended position in which the point of the hook protrudes above the top of the body; and (iv) a second attachment portion projecting from the shank between the first attachment portion and the bend, wherein the second attachment portion defines an eye for attachment to a fishing line.

In another aspect, the longitudinal axis is located in a central longitudinal plane of the body, the central longitudinal plane dividing the body into a first portion and a second portion, and wherein the hook is substantially located in said central longitudinal plane.

In another aspect, the point of the hook is located toward the top of the body, and a transition between the shank and the bend is located toward the bottom of the body. Furthermore, the cavity may be open at the bottom of the body, and wherein the transition between the shank and the bend projects from the bottom of the body when the hook is in the retracted position.

In another aspect, the first attachment point comprises an eye located at an end of the shank which is distal to the bend. The lure may further comprise a transverse pivot rod extending through the eye of the first attachment portion.

In another aspect, the second attachment portion projects from the shank toward the top of the body. The second attachment portion may project at an angle of about 75 to 105 degrees from the shank, for example at an angle of about 90 degrees from the shank.

In another aspect, the second attachment portion may be provided with an eye for attachment of a fishing line, wherein the eye of the second attachment portion is located at an end of the second attachment portion which is opposite to an end at which the second attachment portion joins the shank.

In another aspect, the eye of the second attachment portion projects from the top of the body with the hook in the extended position.

In another aspect, the second attachment portion is integrally formed with the shank, and is formed by bending the shank.

In another aspect, the spring is a coil spring having a first end connected to the hook and a second end connected to the body.

In another aspect, the first end of the spring is connected to the hook proximate to a point at which the second attachment portion projects from the shank. For example, the second end of the spring is located toward the front end of the body, and wherein the first end of the spring is connected to the shank rearwardly of the point at which the second attachment portion projects from the shank.

In another aspect, the front end of the body is provided with an aperture for receiving a fishing line, wherein the aperture is located proximate to the second attachment portion.

### BRIEF DESCRIPTION OF THE DRAWINGS

The invention will now be described, by way of example only, with reference to the accompanying drawings in which:

FIG. 1 is a sectional side elevation view of a lure according to the invention;

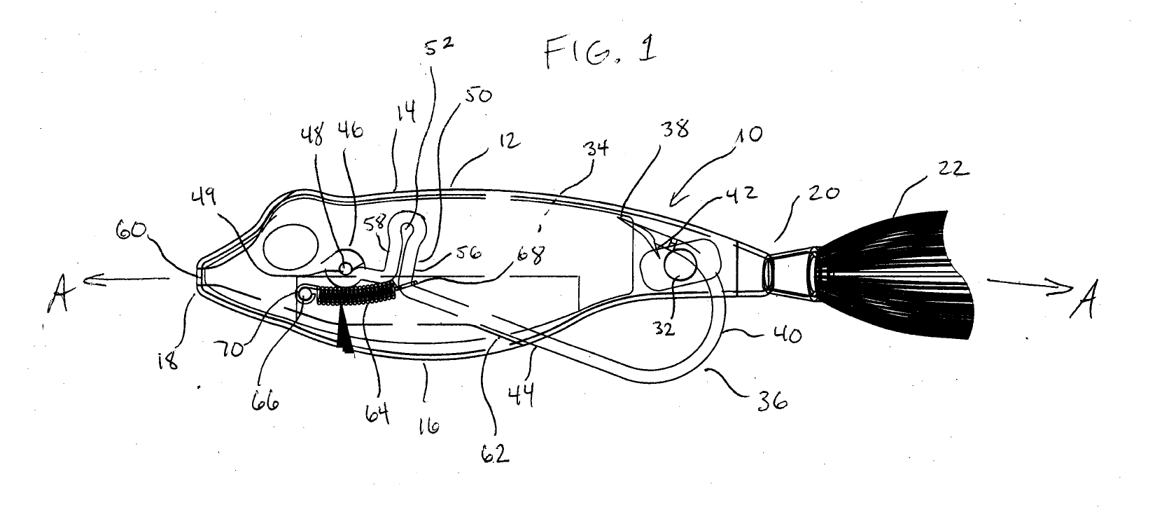

FIG. 2 is a sectional top plan view of the lure of FIG. 1; and

FIG. 3 is a side view showing the hook in the retracted and extended positions;

### DETAILED DESCRIPTION

The lures according to the invention are generally referred to as “weedless” lures. These lures are attached to a fishing line and are generally cast into a body of water with a fishing rod. The lure is then retrieved through the water using a reel attached to the rod. The appearance and movement of the lure are designed to attract fish. The lure has one or more fish hooks to hook a fish when it strikes the lure.

Weedless lures are provided with mechanisms for preventing the hook from becoming caught on water plants or other objects in the body of water being fished. The lures according to the invention are rendered weedless by the provision of a retractable hook. The point of the hook is normally withdrawn inside the body of the lure as it is retrieved through the water, thereby permitting the lure to be retrieved through water which is rich in vegetation. However, when a fish strikes the lure and the line is pulled taut, the point of the hook is brought out of the body and into position to hook the fish, typically in the top of the mouth.

A lure 10 according to an embodiment of the invention is now described with reference to the drawings.

Lure 10 is an artificial fishing lure having a body 12 in the shape of a frog. This particular lure configuration is a floating lure which is intended to be retrieved at or slightly below the surface of the water. The lure may be weighted to provide a desired action when it is retrieved. Although a specific lure configuration is described herein, it will be appreciated that the present invention is applicable to lures of different types, shapes and designs, whether floating or sinking.

The body 12 of lure 10 has a top 14, a bottom 16, a front end 18 and a rear end 20. To give the appearance of a frog moving through the water, the top 14 has the appearance of the frog's back, the bottom 16 is the belly, the front end 18 is the mouth and the rear end 20 is the back of the frog, with skirts 22 imitating a frog's legs.

The lure body 12 defines a longitudinal axis A extending between the front end 18 and the rear end 20 of the body 12.

The lure body 12 is comprised of two portions, a first portion 24 and a second portion 26. Each portion 24, 26 is provided with a sealed, hollow chamber 28, 30 so that the lure 10 will float. The portions 24, 26 may be provided with weights to provide the lure with a desired action during retrieval. In lure 10 the portions 24, 26 are provided with weights in the form of metal balls 32 located toward the rear end of body 12. The rear-weighting of lure 10 in this manner provides it with action known as “walking the dog”.

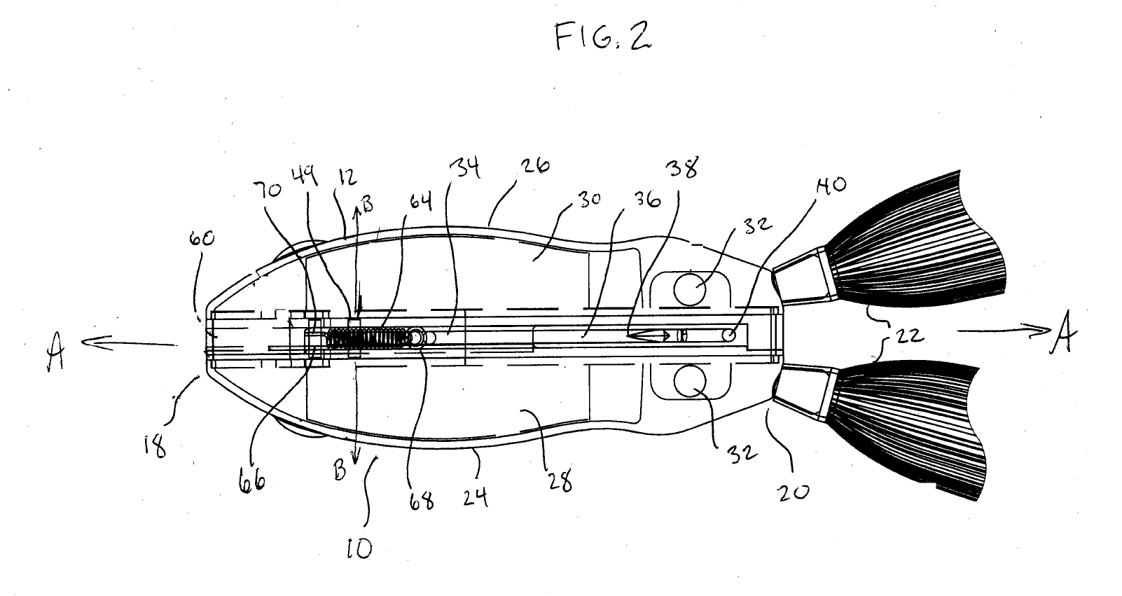

As shown in FIG. 2, the two portions 24, 26 of lure body 12 are located on opposite sides of the longitudinal axis A, and a cavity 34 is defined within the body 12 between the two portions 24, 26. The cavity 34 extends along the longitudinal axis A and extends from a point proximate to the front end 18 of body 12 to a point proximate to the rear end 20. The cavity 34 is open at the top 14 of body 12, and in the illustrated embodiment the cavity 34 is also open at the bottom 16 of body 12. However, it will be appreciated that it may not be desirable for the cavity 34 to be open at the bottom 16 of body 12 in all embodiments of the invention.

Lure 10 further comprises a fish hook 36 which is at least partially received inside the cavity 34 of lure body 12. The fish hook 36 includes a pointed end 38 and a bend 40 located toward the rear end 20 of lure body 12. As shown in the drawings the pointed end 38 may be provided with a barb 42. The bend 40 forms a smooth curve of about 180 degrees, with the pointed end 38 directed toward the front end 18 of lure body 12.

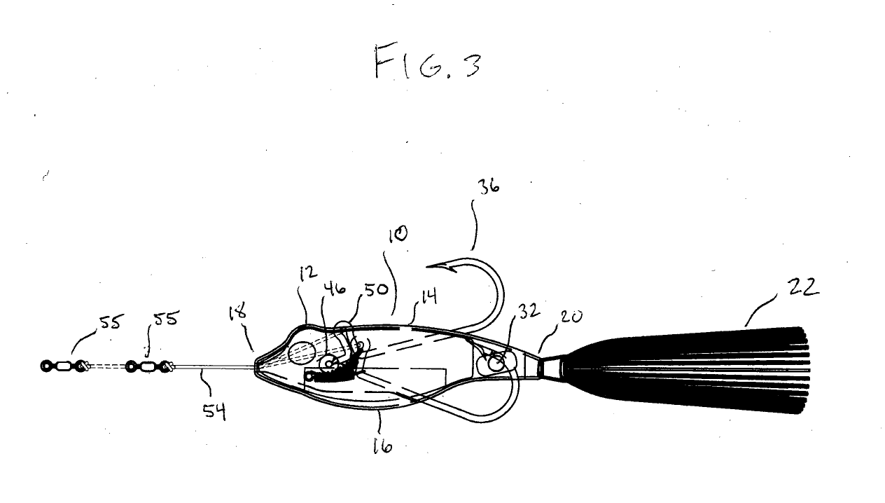

The fish hook 36 further comprises a shank 44, which extends from the bend 40 toward the front end 18 of the lure body 12. The shank 44 extends generally along the longitudinal axis toward the front end 18 of lure body 12 although, as shown in FIG. 3, the shank 44 is generally angled relative to the longitudinal axis A.

A first attachment portion 46 is provided at an end of the shank 44, the attachment portion 46 being opposite to the end of shank 44 which is joined to the bend 40. The first attachment portion 46 defines a pivot axis B which is transverse to longitudinal axis A. As shown in FIG. 3, the hook 36 is pivotable about the pivot axis B between a retracted position in which the point 38 of the hook 36 is located inside the body 12, i.e. it is completely received within the cavity 34, and an extended position in which the point 38 of hook 36 protrudes above the top 14 of body 12, and points in the forward direction, i.e. toward the front end 18 of body 12.

In the embodiment shown in the drawings, the first attachment portion 46 comprises a loop or eye 48 which is integrally formed with shank 44, and the eye 48 is located at the end of shank 44 which is opposite to the bend 40. In this embodiment the lure 10 further comprises a pivot rod 49 which extends transversely across cavity 34 along axis B, located proximate to the front end 18 of body 12. Each end of pivot rod 49 is secured to an opposite portion 24, 26 of body 12, and the pivot rod 49 extends through the eye 48 of the first attachment portion 46.

The hook 36 further comprises a second attachment portion 50 which projects from the shank 44 between the first attachment portion 46 and the bend 40 located at the opposite end of shank 44. Located at the end of the second attachment portion 50 distal to the shank 44 is an eye 52 for attachment of a fishing line 54, for example by a knot. The lure 10 may be tied directly to line 54 by the user of lure 10, or a short length of line 54 with a swivel connector 55 may be tied to the lure at the factory. The swivel connector 55 provides a convenient means for attaching lure 10 to a fishing line.

For maximum strength, the second attachment portion 50 may be integrally formed with the shank 44 of hook 36. This can be done, as shown in the drawings, by forming first and second bends in the shank to provide the second attachment portion with two projecting, parallel legs 56, 58, which are joined at their distal ends by eye 52. This construction gives the second attachment portion 50 a somewhat hairpin-like appearance.

As shown, the second attachment portion 50 projects from the shank 44 toward the top of the body 12. With the hook 36 in its retracted position the eye 52 of the second attachment portion 50 is located within cavity 34. However, when the hook 36 is pivoted toward its fully extended position, the second attachment portion 50 is pivoted toward the top of body 12. Finally, when the hook 36 is pivoted to its fully extended position, the eye 52 will project above the top 14 of body 12, such that the eye 52 is accessible to the user of the lure 10 when it is necessary to re-tie the knot in the fishing line 54.

It can be seen from the drawings and the above description that the second attachment portion 50 acts like a lever which is actuated by pulling on the fishing line 54 attached to eye 52, and causes the hook 36 to pivot about pivot rod 49. The fishing line 54 extends from eye 52 and out of an aperture 60 in the front end 18 of body 12, which in this embodiment is the frog's mouth. All of the components of the hook 36 are substantially located in a central longitudinal plane of the lure 10, this plane including the central longitudinal axis A. The pivoting of the hook 36 also takes place in this central longitudinal plane.

The angle at which the second attachment portion 50 projects from shank 44 is significant, as it will affect the extent to which the hook 36 will pivot. The inventor has found that angles ranging from about 75 to about 105 degrees provide adequate results, with the angle in the illustrated embodiment being about 90 degrees.

In the illustrated embodiment the cavity 34 is open to the bottom 16 of the lure body. With the hook 36 in its retracted position a portion of the shank 44 and a portion of bend 40 extend from the bottom 16 of body 12. Therefore, when a fish strikes the lure 10 and bites down on it, the portions of hook 36 projecting from the bottom will be forced upwardly, causing the hook 36 to pivot and exposing the point 38 of hook 36. Thus, the hook 36 is caused to pivot by the striking action of the fish, increasing the likelihood that the hook will be properly set once the fishing line is pulled and made taut by the user.

The opening at the bottom 16 of body 12 is located toward the rear end 20 of body 12. It can be seen that the shank 44 of hook 36 engages an inner surface 62 of body 12 with the hook 36 in the retracted position. The inner surface 62 acts as a stop to prevent the hook 36 from extending too far from the bottom 16 of body 12, which could possibly expose the point 38 of hook 36.

The lure 10 further comprises a spring 64 located in the body 12 of lure 10, for biasing the hook 36 toward its retracted position. The spring 64 may be of any suitable form and, in the illustrated embodiment, is a coil spring. A first end 68 of spring 64 is attached to the hook 36, and a second end 70 of spring 64 is attached to the body 12 of lure 10. Where the spring 64 is a coil spring with connecting loops at its ends 68, 70, connection to the lure body 12 may be accomplished by providing a second transverse rod 66 extending across the cavity 34, and looping the connecting loop of second end 70 around the rod 66 as shown in the drawings.

The first end 68 of spring 64 may also be provided with a connecting loop which loops around the shank 44 of hook 36. As shown, the first end 68 of spring 64 is attached to shank 44 immediately to the rear of the second attachment portion 50, so that there is no slippage of the spring 64 along the shank 44.

In the embodiment shown in the drawings, the second end 70 of spring 64 is located toward the front end 18 of body 12 and the first end 68 is located toward the rear end 20, however this arrangement is not necessary in all embodiments. In some embodiments of the invention the first end 68 of spring 64 is located forward of the second end 70 of spring 64. In such an arrangement, the first end 68 of spring 64 will be attached to the shank 44 immediately in front of the second attachment portion 50, to avoid slippage of the spring 64 along the shank 44.

It can be seen that pivoting of hook 36 from the retracted position to the extended position will cause the spring 64 to stretch. Therefore, when the pivoting force is removed, the spring 64 will compress and the hook 36 will be retracted back to its original, retracted position.

In use, the lure 10 is attached to a fishing line 54 and cast into a body of water. During the cast and subsequent retrieval of the lure 10 the hook 36 remains retracted, and the lure 10 is weedless. However, when a fish strikes the lure 10 and bites down on it, the user pulls the fishing line tight and causes the hook 36 to pivot to its extended position, causing the hook 36 to become embedded in the fish's mouth. Once the fish is released, the hook 36 springs back to its original, retracted position.

Although the invention has been described in connection with certain embodiments, it is not limited thereto. The invention includes all embodiments which fall within the scope of the claims.

What is claimed is:

1. A fishing lure, comprising:
(a) a body having a top, a bottom, a front end and a rear end, with a longitudinal axis being defined between the front end and the rear end of the body;
(b) a cavity defined within the body, wherein the cavity extends along the longitudinal axis and is open at the top of the body;
(c) a fish hook at least partially received in the cavity, wherein the fish hook comprises:
(i) a pointed end and a bend located toward the rear end of the body;
(ii) a shank extending from the bend, wherein the shank extends toward the front end of the body;
(iii) a first attachment portion located at an end of the shank opposite to the bend of the fish hook, wherein the first attachment portion defines a transverse pivot axis about which the fish hook is pivotable between a retracted position in which the point of the hook is located inside the body, and an extended position in which the point of the hook protrudes above the top of the body;
(iv) a second attachment portion projecting from the shank between the first attachment portion and the bend, wherein the second attachment portion defines an eye for attachment to a fishing line;
(d) a spring located inside the body and attached to the hook, wherein the spring biases the hook toward the retracted position.

2. The fishing lure of claim 1, wherein the longitudinal axis is located in a central longitudinal plane of the body, the central longitudinal plane dividing the body into a first portion and a second portion, and wherein the hook is substantially located in said central longitudinal plane.

3. The fishing lure of claim 1, wherein the point of the hook is located toward the top of the body, and a transition between the shank and the bend is located toward the bottom of the body.

4. The fishing lure of claim 3, wherein the cavity is open at the bottom of the body, and wherein the transition between the shank and the bend projects from the bottom of the body when the hook is in the retracted position.

5. The fishing lure of claim 1, wherein the first attachment point comprises an eye located at an end of the shank which is distal to the bend.

6. The fishing lure of claim 5, wherein the lure further comprises a transverse pivot rod extending through the eye of the first attachment portion.

7. The fishing lure of claim 1, wherein the second attachment portion projects from the shank toward the top of the body.

8. The fishing lure of claim 1, wherein the second attachment portion projects at an angle of about 75 to 105 degrees from the shank.

9. The fishing lure of claim 1, wherein the second attachment portion projects at an angle of about 90 degrees from the shank.

10. The fishing lure of claim 1, wherein the second attachment portion is provided with an eye for attachment of a fishing line, wherein the eye of the second attachment portion is located at an end of the second attachment portion which is opposite to an end at which the second attachment portion joins the shank.

11. The fishing lure of claim 1, wherein the eye of the second attachment portion projects from the top of the body with the hook in the extended position.

12. The fishing lure of claim 1, wherein the second attachment portion is integrally formed with the shank, and is formed by bending the shank.

13. The fishing lure of claim 1, wherein the spring is a coil spring having a first end connected to the hook and a second end connected to the body.

14. The fishing lure of claim 1, wherein the first end of the spring is connected to the hook proximate to a point at which the second attachment portion projects from the shank.

15. The fishing lure of claim 14, wherein the second end of the spring is located toward the front end of the body, and wherein the first end of the spring is connected to the shank rearwardly of the point at which the second attachment portion projects from the shank.

16. The fishing lure of claim 1, wherein the front end of the body is provided with an aperture for receiving a fishing line, wherein the aperture is located proximate to the second attachment portion.
